(19) United States
(12) Patent Application Publication
(10) Pub. No.: US 2018/0259737 A1
(43) Pub. Date: Sep. 13, 2018

(54) High-Speed Communication System and Method with Enhanced Security

(71) Applicant: Korea Advanced Institute of Science and Technology, Daejeon (KR)

(72) Inventors: Chang Hee Lee, Daejeon (KR); Pyeong Il Hwang, Daejeon (KR); Sang Haw Yoo, Daejeon (KR); Myeong Gyun Kye, Daejeon (KR); Seung Hyeon Ahn, Daejeon (KR); Yong Jun Jeong, Daejeon (KR); Seung Rae Cho, Daejeon (KR); Jong Wan Kim, Daejeon (KR)

(21) Appl. No.: 15/754,919

(22) PCT Filed: Feb. 18, 2016
(86) PCT No.: PCT/KR2016/001658

§ 371 Date: Jun. 1, 2018

(30) Foreign Application Priority Data
Aug. 24, 2015 (KR) 10-2015-0119056
Feb. 18, 2016 (KR) 10-2016-0019300

(51) Int. Cl. G02B 6/44; H04B 10/071; H04L 9/08; H04L 29/06; G02B 6/35

(52) U.S. Cl. CPC G02B 6/4469; H04B 10/071; H04W 12/04; H04L 63/1475; G02B 6/3598; H04L 9/0819

(57) ABSTRACT

Disclosed is a scheme of transmitting at least two or more transmission signals, in which at least two or more pure random noise signals are contained, through multiple paths, according to one embodiment of the present invention. To implement such a scheme, a complementary noise generator may be used in a high-speed communication method and system with enhanced security according to the present invention. Here, the complementary noise generator refers to an apparatus in which a total sum of summing altogether at least two or more generated noises becomes 0. Namely, the complementary noise generator can generate m noises, and the sum of the in noises becomes 0. By injecting a plurality of noises having such feature into different paths, a channel capacity of each channel is reduced, thereby making a single wiretapping difficult. In comparison, because a receiver receiving a plurality of transmission signals with injected noises receives all noise signals and then sums up the noise signals, the noises are offset, and it is possible to effectively receive the original signal (random key K) intended for transmitting by a transmitter.

### TECHNICAL FIELD

The teachings in accordance with the exemplary embodiments of this present disclosure generally relate to an apparatus and method for high speed communication with perfect secrecy.

### BACKGROUND

A fundamental problem in communication theory is how to transmit a message between two parties without a third party also being able to obtain the message. For example, in the field of electronic financial transactions, it is very important to maintain secrecy in the communication between two parties.

Conventionally, the two parties who wish to exchange a message are known respectively as Alice and Bob, while an eavesdropper who wishes to gain unauthorized access to the message is known as Eve.

Many communication techniques have been developed to solve this problem. One class of techniques relies on the computational limitations of Eve that prevent her from performing certain mathematical operations in a reasonable time. For example, the security of the RSA public key cryptographic technique relies heavily on the computational difficulty in factoring very large integers. Techniques of this type are known as “conditionally secure” or “computationally secure”.

One problem with conditionally secure techniques is that confidence in their security relies on mathematical results in the field of complexity theory that remain unproven, Therefore, it cannot be certain at present that such techniques will not be broken in the future, using only the resources of a classical computer, if appropriate mathematical tools for doing so can be developed.

As one of solutions thereto is a security of a quantum key distribution (QKD) system by adding classical encryption to the quantum key distribution process. Although the encryption method perfectly guarantees the security regardless of computational performances of an eavesdropper (“Eve”) or wiretapper by using a basic principle of quantum mechanics, the key generation rate (effective key bit/total transmission bit) based on single photon light source is low, approximately less than 10-4, and is physically weak to a so-called “side channel attack” attacking a communication system and breaking a security.

The key generation rate can be ascertained from the information theoretical approach of A. D. Wyner, and the key generation rate may be a value in which a channel capacity of transmitter (Alice) and receiver (Bob) is subtracted by a channel capacity of eavesdropper (Eve). Here, the channel capacity of transmitter (Alice) and receiver (Bob) can be changed in response to construction method of communication channel environment. Thus, in order to maximize the key generation rate guaranteeing a perfect security, there is required a need of minimizing a channel capacity of the transmitter (Alice) and receiver (Bob) and the present disclosure is based thereon.

### SUMMARY

### Technical Subject

The technical subject to be solved by the present disclosure is to provide an apparatus and method for high speed communication with perfect secrecy configured to build an absolute security system fundamentally blocking the temporability or eavesdropping possibility using a physical characteristic embedded in a channel unlike a security system relying on computational complexity whose confidence remains unproven.

The present disclosure provides a communication system and method configured to increase an encryption key generation speed up to a transmission speed of conventional information because the present disclosure is not based on a single photon light source.

Another object of the present disclosure is to provide an apparatus and method for high speed communication with perfect secrecy increased in economic feasibility and compatibility due to applicability or useability to various communication channels including various technologies of conventional optical communication.

### Technical Solution

The technical subject to be solved by the present disclosure is to provide an apparatus and method for high speed communication with perfect secrecy configured to build an absolute security system fundamentally blocking the temporability or eavesdropping possibility per se based on informational theory by minimizing a channel capacity of an eavesdropper while optimizing a channel capacity between transmitter and receiver utilizing a physical characteristic embedded in a channel unlike a security system relying on computational complexity.

In one general aspect of the present disclosure, there is provided an apparatus for high speed communication with perfect secrecy disposed with an OTDR (Optical Time Domain Reflectometer) increased in sensitivity, wherein the sensitivity-increased OTDR includes:

a first light source applying a first optical pulse to an optical communication path;

a coupler outputting the first optical pulse by dividing the first optical pulse at least more than two paths;

an optical coupler determining a point applied with the first optical pulse on the optical communication path;

a second light source applying a second optical pulse to an optical communication path weaker in intensity than that of the first optical pulse in response to a point applied with the first optical pulse to the optical communication path;

an optical receiver receiving an optical signal returning by being reflected from the optical communication path; and

a controller analyzing or predicting a signal leakage of the optical communication path based on a result detected from the optical receiver.

Preferably, but not necessarily, the apparatus may further comprise:

a first circulator transmitting a first optical pulse outputted from the coupler to the optical communication path, and transmitting the optical signal returning by the first optical pulse being reflected from the optical communication path to the optical receiver; and

a second circulator transmitting a second optical pulse outputted from the second light source to the optical communication path and transmitting an optical signal returning by the second optical pulse from the optical communication path.

Preferably, but not necessarily, the apparatus may further comprise: a delay path connected to an optical detector to transmit a signal controlling operations of the second light source and the optical receiver based on a point of the first optical pulse being applied to the optical communication path to the second light source and the optical receiver.

Preferably, but not necessarily, the apparatus may further comprise: a WDM (Wavelength Division Multiplexing) filter disposed between the first and second circulators to transmit optical pulses of mutually different wavelengths received from the first and second circulators to the optical communication path, and to transmit each of optical signals of mutually different wavelengths that return by being reflected from the optical communication path by dividing the optical signals of mutually different wavelengths to the first and second circulators.

Preferably, but not necessarily, the optical signal including the second optical pulse that returns by being reflected from the optical communication path may include an optical signal reflected by the second optical pulse in response to a refractive index corresponding to an instant point to catch up the first optical pulse.

In another general aspect of the present invention, there is provided a method for high speed communication with perfect secrecy, the method comprising:

transmitting a first key (K1) to a second communication user by generating, by a first communication user, the first key (K1);

transmitting to the first communication user by generating, by the second communication user, a second key (K2); and

obtaining, by the first communication user or the second communication user, an encryption key, based on the first key and the second key.

Preferably, but not necessarily, the first communication user and the second communication user may be mutually connected through at least one communication path, and a channel capacity between the first communication user and the second communication user may be greater than that between the first communication user or the second communication user and an eavesdropper.

In still another general aspect of the present invention, there is provided a method for high speed communication with perfect secrecy, the method comprising:

transmitting, by a first communication user, to a second communication user, a transmission signal respectively infused with n number of noises (n is a natural number greater than 1) through m number of communication paths (in is a natural number greater than 1); and

obtaining the transmission signal, based on a transmission signal respectively contained with the n number of noises received by the second communication user.

Preferably, but not necessarily, a sum of n number of noises may be 0, and the second communication user may obtain the transmission signal by offsetting the n number of noises,

Preferably, but not necessarily, the n number of noises may be generated by a complementary noise generator and the step of transmitting, by a first communication user, to a second communication user, a transmission signal respectively infused with n number of noises (n is a natural number greater than 1) through m number of communication paths (m is a natural number greater than 1) may include a step of performing a signal modulation and distributing to the m number of communication paths, based on any one noise and the transmission signal among the n number of noises.

Preferably, but not necessarily, the method may further include generating the n number of noises, and the method of generating the n number of noises may include:

distributing an optical source to a p number of channels (p is a natural number greater than n) by passing an output of BLS (Broaden Light Source) having a broad wavelength band to a first AWG (Arrayed Waveguide Grating);

infusing to an RSOA (Reflective Semiconductor Optical Amplifier) by coupling the n number of optical source in the optical sources distributed to the p number of channels using a BS (Beam Splitter); and

classifying an output of the RSOA as the n number of noises by passing a second AWG.

In still further general aspect of the present invention, there is provided a method for high speed communication with perfect secrecy, the method comprising:

outputting an optical source corresponding to at least two modes based on a security data and multi-mode laser;

distributing the optical source to at least two paths based on a first WDM filter; modulating a signal transmitted from the first WDM filter based on a signal modulator;

demodulating a signal transmitted through an optical communication path based on a signal demodulator;

offsetting noises included in individual modes of demodulated signals based on a second WDM filter; and

obtaining the security data.

Preferably, but not necessarily, the step of outputting an optical source corresponding to at least two modes based on a security data and multi-mode laser may include restricting noises existent in the at least two modes by infusing an output of an ASE (Amplified Spontaneous Emission) to the multi-mode laser.

In still further general aspect of the present invention, there is provided a method for high speed communication with perfect secrecy, the method comprising:

dividing a security data to at least two or more transmission signals;

injecting at least two or more noises into two or more transmission signals respectively;

transmitting the at least two or more transmission signals respectively injected with the at least two or more noises to a receiver through a plurality of mutually different paths; and

obtaining the security data based on the at least two or more transmission signals injected with the at least two or more noises frequently received from the receiver.

Preferably, but not necessarily, a sum of the at least two noises may be 0, and the receiver may offset the at least two noises to obtain the security data.

In still further general aspect of the present invention, there is provided a method for high speed communication with perfect secrecy, the method comprising:

transmitting, by a first communication user, to a second communication user, a signal include with a part of noises in a plurality of complementary noises through a single path and storing remaining noises in the plurality of complementary noises through other paths;

generating a transmission signal by modulating the signal received by the second communication receiver and transmitting the transmission signal to the first communication user through the single path; and

obtaining the transmission signal based on a modulated signal returned by the first communication user to the second communication user and the stored remaining noises.

Preferably, but not necessarily, the step of obtaining the transmission signal based on a modulated signal returned by the first communication user to the second communication user and the stored remaining noises may include obtaining the transmission signal by offsetting the plurality of complementary noises by aggregating the modulated signal returned by the first communication user from the second communication user with the stored remaining noises.

Preferably, but not necessarily, the first communication user and the second communication user may share in secret an encryption key used for modulation and demodulation of signals.

Preferably, but not necessarily, a length of the different path may be twice the length of the single path.

In still further general aspect of the present invention, there is provided a method for high speed communication with perfect secrecy, the method comprising:

modulating, by each of a first communication user and a second communication user, a signal relative to noises based on at least two signal transmitters and source noise;

transmitting, by each of the first communication user and the second communication user, the modulated signal to other users through at least one path; and

restricting, by each of the first communication user and the second communication user, noises included in the received signal and compensating a distortion phenomenon of the signal, wherein

the at least one path includes at least one communication network in an optical communication path realized for bi-directional communication, a wireless communication channel and wired communication channel.

### Advantageous Effects

The advantageous effect of to the apparatus and the method for high speed communication with perfect secrecy according to the present invention will be described as under:

According to an exemplary embodiment of the present invention, an absolute security system can be constructed that fundamentally blocks the eavesdropping possibility per se using a physical characteristic embedded in a channel, unlike a security system relying on computational complexity whose confidence remains unproven.

Furthermore, according to at least one of the exemplary embodiments, an encryption key generation speed can be increased up to a transmission speed of conventional information because the present disclosure is not based on a single photon light source.

Furthermore, according to at least one of the exemplary embodiments, economic feasibility and compatibility can be increased due to applicability or useability to various communication channels including various technologies of conventional optical communication.

### BRIEF DESCRIPTION OF DRAWINGS

FIG. 1 is a schematic view illustrating a system capable of detecting an existence of an eavesdropper with hypersensitivity.

FIG. 2 is a schematic view illustrating a conventional OTDR (Optical Time Domain Reflectometer).

FIG. 3 is a schematic view illustrating a hypersensitivity OTDR included in an exemplary embodiment of the present invention.

FIG. 4 is a schematic view illustrating in detail an operation method of a hypersensitivity OTDR included in an exemplary embodiment of the present invention.

FIG. 5 is a schematic view illustrating in detail a hypersensitivity OTDR included in an exemplary embodiment of the present invention.

FIG. 6 is a schematic view illustrating a method making it difficult to eavesdrop by using a communication algorithm included in an exemplary embodiment of the present invention.

FIG. 7 is a schematic view illustrating a method making it physically difficult to eavesdrop by using a source noise included in an exemplary embodiment of the present invention.

FIG. 8 is a schematic view illustrating an example of generating a complementary noise included in an exemplary embodiment of the present invention.

FIG. 9 is a schematic view illustrating an example of generating a complementary noise of FIG. 8 by realizing through an actual experiment.

FIGS. 10 and 11 are schematic views illustrating a status before and after application to RSOA explained through FIG. 9.

FIG. 12 is a schematic view illustrating a result calculating a maximum channel capacity possessed by a targeted receiver and an eavesdropper (Eve) based on a noise according to an exemplary embodiment of the present invention.

FIG. 13 is a schematic view illustrating an example applied with multipath security system in an optical communication according to an exemplary embodiment of the present invention.

FIG. 14 is a schematic view illustrating an example applied with multipath security system using a noise according to an exemplary embodiment of the present invention.

FIG. 15 is a schematic view illustrating an example applied with a single path security system using a noise according to an exemplary embodiment of the present invention.

FIG. 16 is a schematic view illustrating an example applied with a bi-directional multipath security system according to an exemplary embodiment of the present invention.

### DETAILED DESCRIPTION

Various exemplary embodiments will be described more fully hereinafter with reference to the accompanying drawings, in which some exemplary embodiments are shown.

In describing the present invention, detailed descriptions of constructions or processes known in the art may be omitted to avoid obscuring appreciation of the invention by a person of ordinary skill in the art with unnecessary detail regarding such known constructions and functions. In the drawings, the size and relative sizes of layers, regions and/or other elements may be exaggerated or reduced for clarity.

Accordingly, in some embodiments, well-known processes, well-known device structures and well-known techniques are not illustrated in detail to avoid unclear interpretation of the present disclosure. Terms used in the specification are only provided to illustrate the embodiments and should not be construed as limiting the scope and spirit of the present disclosure. The same reference numbers will be used throughout the specification to refer to the same or like parts.

In describing elements of exemplary embodiments according to the present disclosure, the terms “-er”, “-or”, and “module” described in the specification mean units for processing at least one function and operation and can be implemented by hardware components or software components, and combinations thereof Terms used in the specification are only provided to illustrate the embodiments and should not be construed as limiting the scope and spirit of the present disclosure.

In addition, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section.

It will be understood that when an element such as a layer, region or substrate is referred to as being on or extending “onto” another element, it can be directly on or extend directly onto the other element or intervening elements may also be present. In contrast, when an element is referred to as being “directly on” or extending “directly onto” another element, no intervening elements are present. It will also be understood that when an element is referred to as being “connected” or “coupled” to another element, it can be directly connected or coupled to the other element or intervening elements may be present. In contrast, when an element is referred to as being “directly connected” or “directly coupled” to another element, no intervening elements are present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present disclosure will be described in detail with reference to the accompanying drawings. It should be apparent that the present disclosure may be embodied in other specific forms not escaping from the spirits and essential characteristics of the present disclosure.

The exemplary embodiments presented by the present disclosure may minimize the potential eavesdropping and reinforce the secrecy in communication system by combining at least one or two concepts out of three concepts based on systems, the systems including: a system restricting information volume of eavesdropper by sensitively detecting leakage of signals; a system restricting an eavesdropping position of a single eavesdropper and information volume through bi-directional communication on a single communication line; and a MIMO (Multiple input Multiple Output) system using a path complexity and source noise.

FIG. 1 is a schematic view illustrating a system capable of detecting an existence of an eavesdropper with hypersensitivity.

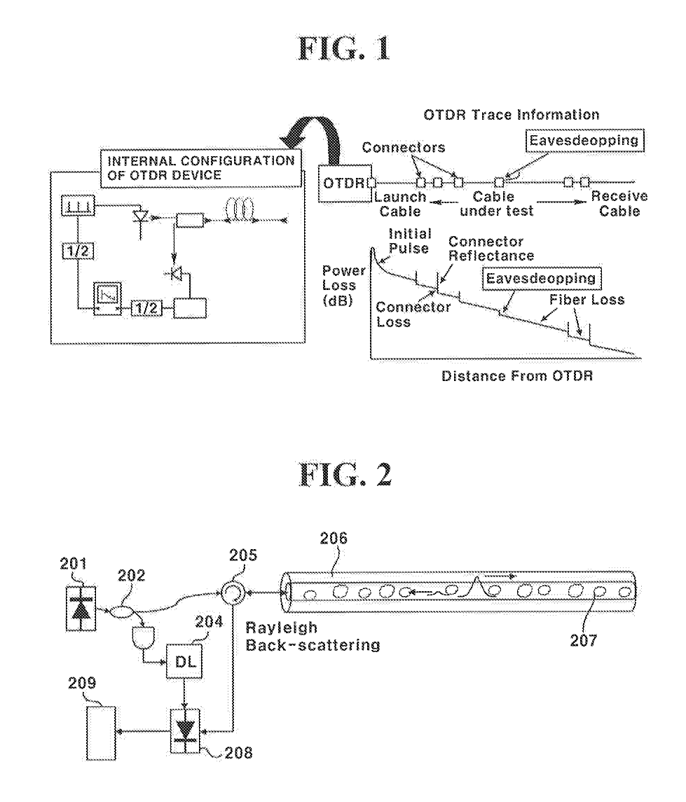

Referring to FIG. 1, a pulse of light may be infused to an optical communication path and a part of the light infused in a pulse may be reflected inside the optical communication path by interaction with particles inside the communication path. Here, the reflected light may be returned to a transmission terminal (Rayleigh scattering), when the amount of returned light is observed in time, leakage of optical signal can be ascertained at a particular time. A detailed explanation thereto will be described with reference to FIG. 2.

FIG. 2 is a schematic view illustrating a conventional OTDR (Optical Time Domain Reflectometer).

Referring to FIG. 2, the OTDR may include a light source (201), a coupler (202), a photodetector (203), a delay line (204), a circulator (205), an optical communication line (206, Optical fiber), an optical receiver (208, APD, Avalanche Photo-Diode) and a controller (209).

First of all, the light source (201) may introduce a light to the optical communication line (206) in the shape of a pulse. Furthermore, the coupler (202) may divide the optical pulse outputted from the light source (201) to at least two paths, and may transmit one optical pulse in the divided optical pulses to the optical communication line (206) and transmit another optical pulse to the photodetector (203). The photodetector (203, PD) may receive the optical pulse transmitted from the coupler (202) to ascertain a time when where the optical pulse is infused into the optical communication line (206).

The delay line (204) may perform a function of ascertaining a time when the optical pulse is infused into the optical communication line (206) through the photodetector (203), and controlling the optical receiver (208) in order to effectively detect a signal returning by being reflected from the optical communication line (206). The circulator (205) is a device for controlling a path of the optical pulse, and may transmit the optical pulse transmitted by being divided from the coupler (202) to the optical communication line (206), and transmit the optical signal returning by being reflected from the optical communication line (206) to the optical receiver (208).

The optical communication line (206, Optical Fiber) may be a path to transmit an optical signal, and become an object to be monitored by the OTDR system. Here, the optical communication line (206) may include impurities or defects (207) inside an optical fiber.

The optical receiver (208, APD, Avalanche Photo-Diode) may perform a function of detecting an optical signal returning by being reflected from the optical communication line (206), and may transmit a detected result to the controller (209). The controller (209, processor) may analyze a state of the optical communication line (206) based on the detected result from the optical receiver (208), that is, analyze leakage of signals.

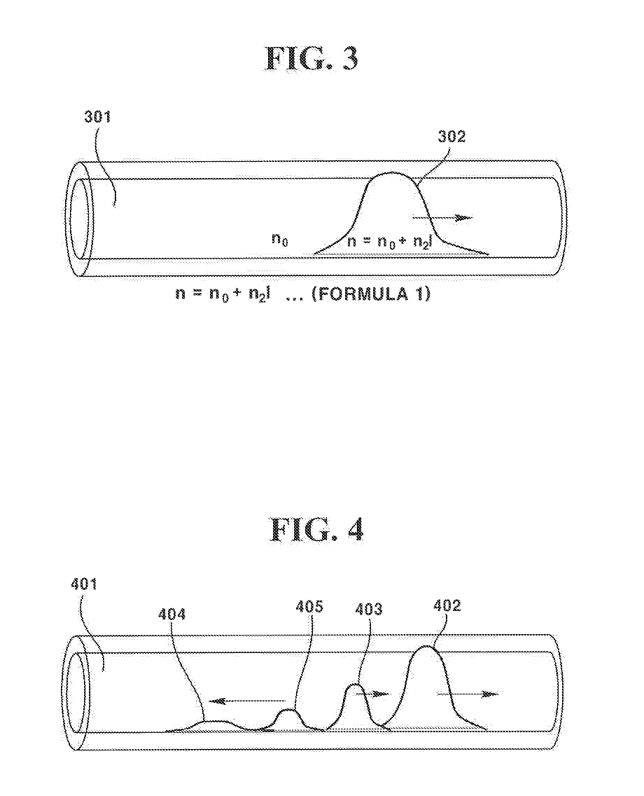

FIG. 3 is a schematic view illustrating a hypersensitivity OTDR included in an exemplary embodiment of the present invention, where n is a refractive index, which is a factor determining a moving speed of light inside a medium. Furthermore, nO indicates an initial refractive index corresponding to when no action is applied, n2 indicates a change of rate (change rate) in refractive index of optical fiber that non-linearly changes in proportion to intensity of light, and l indicates an intensity of light passing through an optical fiber (optical communication line).

When an optical pulse of strong intensity over several mW passes an optical fiber (301, optical communication line), the refractive index of the optical fiber (301) temporarily changes at a point where the optical pulse (302) is present in response to a formula shown at a lower section of FIG. 3. To be more specific, when an optical pulse (302) of strong intensity over several mW passes an inside of the optical fiber (301), the refractive index increases. Furthermore, a light reflection increases at a point where a value of refractive index greatly changes when a light passes a medium.

FIG. 4 is a schematic view illustrating in detail an operation method of a high sensitivity OTDR included in an exemplary embodiment of the present invention.

Referring to FIG, 4, a fiber core (401) may become a path for optical pulses (402, 403, 404, 405) to pass therethrough, where a strong optical pulse (402) indicates a light strong enough in intensity of light as to increase the refractive index of the optical fiber (401) at a point where the strong optical pulse (402) is existent. Furthermore, a weak optical pulse (403) may be an optical pulse weaker in intensity of light than that of the strong optical pulse (402) and is faster in speed than the strong optical pulse (402).

Furthermore, a reflective wave (404) of strong optical pulse indicates an optical pulse returning to a transmission terminal after a part of the strong optical pulse (402) being reflected in an interaction (Rayleigh scattering) with the optical fiber (401), and a reflective wave (405) of weak optical pulse indicates an optical signal returning to the transmission terminal by a part of the weak optical pulse (403) being reflected.

Now, the OTDR included in the present disclosure will be described in more details.

The optical pulse (402) strong enough to exert an influence on the refractive index of the optical fiber is transmitted ahead of a weaker optical pulse (403), and the weaker optical pulse (403) following the strong optical pulse (402) is transmitted later. In this case, because the strong optical pulse (402) is slower than the weak optical pulse (403), the weaker optical pulse (403) overtakes (catches up with) the strong optical pulse (402), where the refractive index of the optical fiber (401) at a point where the strong optical pulse (402) is existent increases as explained before, such that reflection of the weaker optical pulse (403) that has reached the point, that is, the weak optical pulse (403) at the time of catching up with the strong optical pulse (402), is easily generated. The optical signal returning to the transmission terminal by being thus generated is greater in size than an optical signal returning to the transmission terminal by being generally reflected, such that the exemplary embodiment of the present disclosure can detect a physical change of a relevant channel in louder and greater sensitivity.

In case of conventional OTDR, one single strong optical pulse is infused in order to ascertain a communication line one time. Furthermore, a part of the optical pulse is reflected by interaction with the optical fiber to be returned to a transmission terminal where the optical pulse was infused, where a pulse power of the optical signal thus returned by being reflected is merely approximately 0.001%.

However, in case of OTDR included in the exemplary embodiment of the present disclosure, a point of the refractive index being increased due to strong optical pulse (402) is generated, and the weaker optical pulse (403) catching up with the strong optical pulse (402) at the relevant point may be greatly reflected. Because the reflexibility at this time is increased greater than the previously known OTDR, the amount of optical signal is also increased, and the OTDR included in the present exemplary embodiment of the present disclosure can sensitively detect the leakage state of signal at the communication line through the optical signal thus returned.

FIG. 5 is a schematic view illustrating in detail a hypersensitivity OTDR included in an exemplary embodiment of the present invention.

Referring to FIG. 5, a hypersensitivity OTDR may include a first light source (501), a coupler (502), a photodetector (503), a delay line (504a, 504b, 504c), a first circulator (505), a second light source (506), a second circulator (507), a WDM (Wavelength Division Multiplexing) filter (508), an optical communication line (512), an optical receiver (514a, 514b) and a controller (515).

First, the first light source (501) can introduce a light to the optical communication line (512) in the shape of a pulse. The first light source (501) can output a stronger optical pulse (509) than the second light source (506). The coupler (502) can divide the optical pulse outputted from the first light source (501) to at least two paths, and one of the optical pulse of the divided two optical pulses may be transmitted to the optical communication line (512) through the first circulator (505), and remaining optical pulse may be transmitted to the photodetector (503).

The photodetector (503) may receive the optical pulse transmitted from the coupler (502) and ascertain a point where the optical pulse was infused into the optical communication line (512). The delay line (504) may perform a function of ascertaining a point where the optical pulse is infused into the optical communication line (512) through the photodetector (503) and transmitting a control signal to the second light source (506) and the optical receivers (514a, 514b) at an opportune time. The first circulator (505), a device to control a path of optical pulse, may transmit an optical pulse transmitted by being divided by the coupler (502) to the optical communication line (512) through the WDM filter (508), and may transmit an optical signal transmitted from the WDM filter (508) to the optical receiver (514a).

The second light source (506) may output a weak optical pulse (510) in response to a control signal transmitted from the delay line (504b), where the weak optical pulse (510) outputted from the second light source (506) may be a pulse following the strong optical pulse (509) outputted from the first light source (501) and may be faster in moving speed than the strong optical pulse (509). The second circulator (507) may transmit the weak optical pulse (510) outputted from the second light source (506) to the optical communication line (512) through the WDM filter (508), and may transmit an optical signal transmitted from the WDM filter (508) to the optical receiver (514).

The WDM filter (508) may perform a function of dividing a relevant light to mutually different paths in response to wavelength of light, or adding lights of various wavelengths to one path. Here, the WDM filter (508) may receive optical pulses of mutually different wavelengths from the first circulator (505) and the second circulator (507) and transmit the same to the optical communication line (512). Furthermore, the WDM filter (508) may transmit to the first and second circulators (505, 507) each of optical signals with mutually different wavelengths returning by being reflected from the optical communication line (512)

The strong optical pulse (509), which is an optical pulse outputted from the first light source (501), may temporarily change the refractive index of the optical communication line (512) at an area of its own existence because of the strong intensity of pulse. As a result, the refractive index at a relevant point at the moment of the weak optical pulse (510) overtaking the strong optical pulse (509) is increased, and a probability of the optical pulse being reflected to a direction opposite to the advancing direction can be also increased due to the increased refractive index.

The weak optical pulse (510), an optical pulse outputted from the second light source (506), may be returned to the transmission terminal by being reflected (510a) thereafter from the optical communication line (512). A reflective wave (509a) of the strong optical pulse (509) may be transmitted to the optical receiver (514a) through the WDM filter (508) and the first circulator (505), and a reflective wave (510a) of weak optical pulse (510) may be transmitted to the optical receiver (514b) through the WDM filter (508) and the second circulator (507).

The optical communication line (512), a path transmitting an optical signal, may be an object being monitored by the OTDR system. Here, the optical communication line (512) may include impurities or defects (513) inside the optical communication fiber (communication line).

An optical receiver (514a, 514b, APD, Avalanche Photo-Diode) may perform a function of detecting an optical signal returned by being reflected from the optical communication line (512), and may transmit a detected result to the controller (515). The controller (515) may analyze or predict a state of the optical communication line (512.) based on the result detected from the optical receiver ((514a, 514b), that is, analyze or predict the leakage of signals. In case of FIG. 5, because of there being so many lights returning by being reflected, the state of the optical communication line (512) can be sensitively and accurately detected.

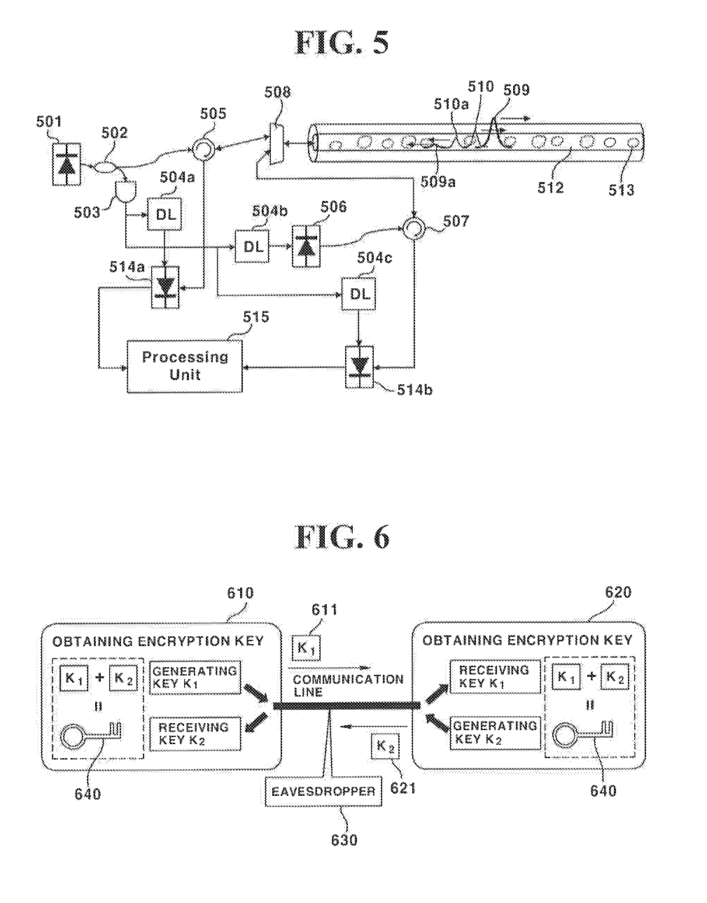

FIG. 6 is a schematic view illustrating a method making it difficult to eavesdrop by using a communication algorithm included in an exemplary embodiment of the present invention.

FIG. 6 illustrates a bi-directional communication, where in case of conventional unidirectional communication, there may be frequently generated a case where the channel capacity of transmitter (Alice) and the eavesdropper (Eve) is better than that of the transmitter (Alice) and the receiver (Bob). This is because obtainment of signal at a position near to the transmitter (Alice) is advantageous in the position of eavesdropper (Eve), and a distance between the transmitter (Alice) and the eavesdropper (Eve) may be shorter than a distance between the transmitter (Alice) and the receiver (Bob). In case of the conventional unidirectional communication, the key generation rate may be decreased that guaranteeing a perfect security in response to the previously explained theoretical approach of A. D. Wrier, and as a result, a success probability of eavesdropping by the eavesdropper can be increased.

Thus, an algorithm (K1+K2) generating an encryption key (640) using bi-directional communication is used in the exemplary embodiment of the present disclosure. As a result, the eavesdropper (Eve) wishing to eavesdrop the bi-directional communication included in the present disclosure must inevitably eavesdrop both directions altogether in order to obtain algorithms (611, 621) and an encryption key (640).

The best position to perform the eavesdropping in the position of a single eavesdropper desired to eavesdrop a bidirectional communication may be an intermediate position between communication users {first communication user (610) and second communication user (620)}. This is because the eavesdropper is advantageous in hiding himself/herself by being distanced from a transmission terminal under the assumption that communication users (610, 620) are monitoring the eavesdropper.

In this case, the position of the eavesdropper (Eve) is distanced from the transmitter (Alice) over the unidirectional communication, and the channel capacity between the communication users (610, 620) can become greater than the channel capacity between the transmitter (610) and the eavesdropper (Eve). As a result, the channel capacity of the eavesdropper (Eve) is more restricted than the unidirectional communication.

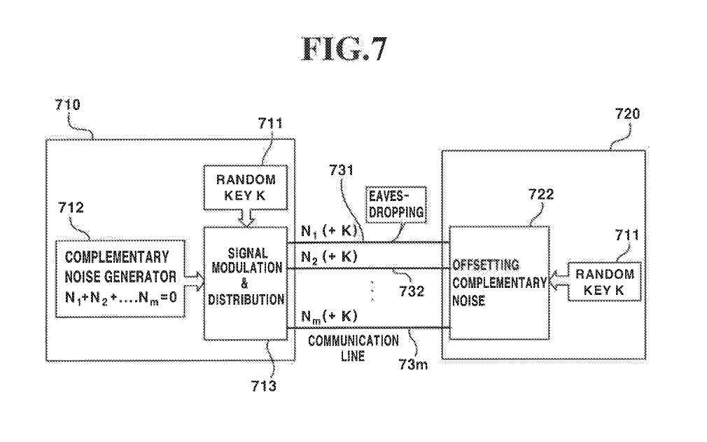

FIG. 7 is a schematic view illustrating a method making it physically difficult to eavesdrop by using a source noise included in an exemplary embodiment of the present invention.

FIG. 7 illustrates a method of transmitting at least two transmission signals applied with at least two pure random noise signals through multiple paths (731, 732, 73m). In order to implement this method, a complementary noise generator (712) may be used in the apparatus and method for high speed communication with perfect secrecy according to the present disclosure. Here, the complementary noise generator (712) is a device where a total sum of generated at least two noises is 0. That is, the complementary noise generator (712) can generate in number of noises, where a sum of relevant in number of noises is 0.

The present disclosure enables the m number of noises to be infused to a plurality of transmission signals transmitted to the in number of mutually different paths (731, 732, 73m). Here, each channel infused with noise can be reduced in channel capacity due to noises, whereby a single eavesdropping becomes difficult. In contrast, a receiver having received a plurality of transmission signals infused with noises may receive a signal relative to all paths of in number, where these signals are added to thereby offset relevant noises to allow effectively receiving an original signal (random key K) desired to be transmitted by the transmitter. However, it is difficult for an eavesdropper (Eve) to receive all the plurality of transmission signals infused with noises, such that security of communication system applied with the apparatus and method for high speed communication with perfect secrecy according to the present disclosure can be guaranteed.

FIG. 8 is a schematic view illustrating an example of generating a complementary noise included in an exemplary embodiment of the present invention.

Referring to FIG. 8, first, an AWG (Arrayed Waveguide Grating, 802) is made to pass an output of a BLS (Broaden Light Source, 801) having a relatively broad wavelength band to allow each channel of AWB (802) to be distributed with a light (optical) source. Here, the optical sources distributed to each channel is relatively large in noise due to beating noise, where a part of sources large in noise is coupled by BS (Beam Splitter, 803) to allow being infused into an RSOA (Reflective Semiconductor Optical Amplifier, 804). The size of noise includes in each channel is not greatly changed if used with a strong gain saturation of RSOA. Meantime, a phenomenon is generated where a sum of total intensities is very small. That is, a complementary noises (λ1, λ2, λ3, λ4) are formed as shown in FIG. 8.

Meantime, the abovementioned BLS (801) may be replaced with other light sources such as F-P LD. Furthermore, the AWB (802) may be all optical components capable of distributing optical filters or beams. Positions of each component are not limited as the positions illustrated in FIG. 8, and may be changed depending on circumstances. Furthermore, although the number of light sources in FIG. 8 is four (4), the number is provided for convenience of explanation, and the number of light sources can be changed.

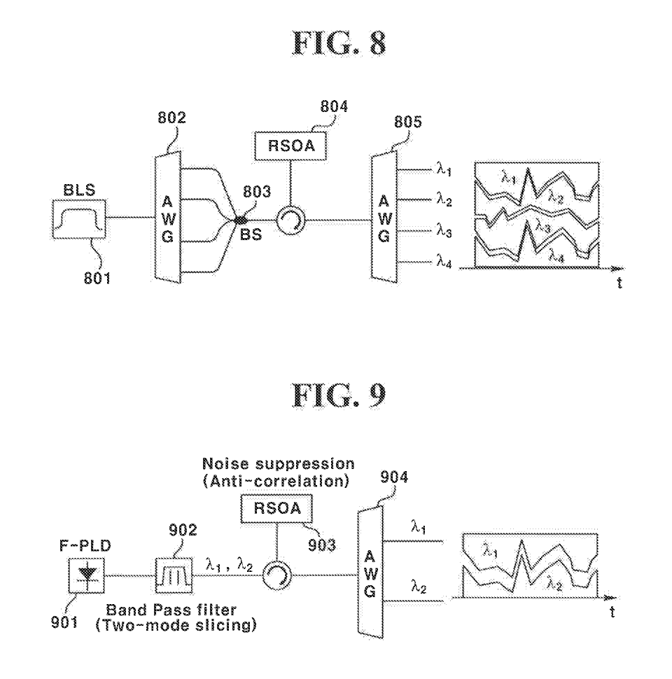

FIG. 9 is a schematic view illustrating an example of generating a complementary noise of FIG. 8 by realizing through an actual experiment.

As explained through FIG. 8, only two modes in an output of F-P LD (901) oscillated in multiple modes are divided by a band pass filter (902), which is then infused into the RSOA (903) to generate complementary noises (λ1, λ2).

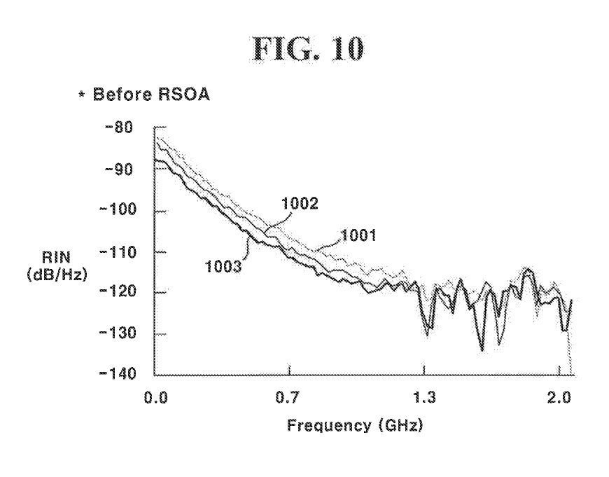

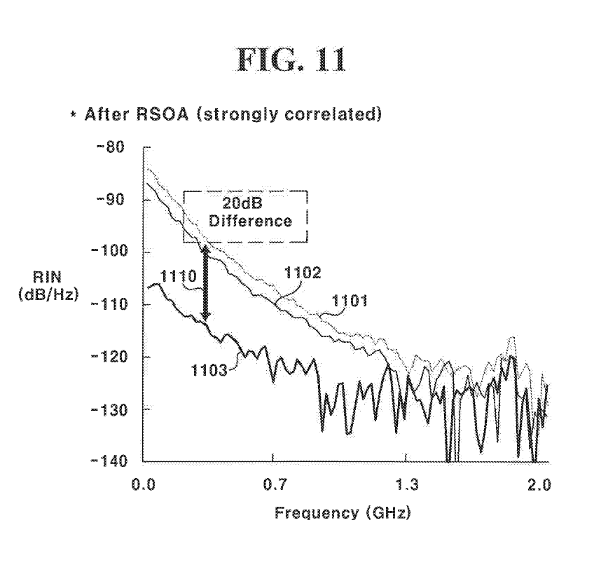

FIGS. 10 and 11 are schematic views illustrating a status before and after application to RSOA explained through FIG. 9.

First of all, FIG. 10 illustrates two noises (1001, 1002) before infusion into RSOA and a result (1003) of two noises being added.

Referring to FIG. 10, it can be ascertained that the noise (1003) is not greatly reduced even if two noises are added due to low interrelationship of noises (1001, 1002) of each mode before infusion into the RSOA.

FIG. 11 illustrates two noises (1101, 1102) after infusion into RSOA and a result (1103) of two noises being added.

Referring to FIG. 11, it can be ascertained that two noise sources (1101, 1102) have a strong interrelationship after being infused into the RSOA, and noise (1103) is mutually offset when two modes are added. To be more specific, it can be ascertained that noise is reduced by approximately 20 dB over each noise source when two noises (1101, 1102) are added (1103).

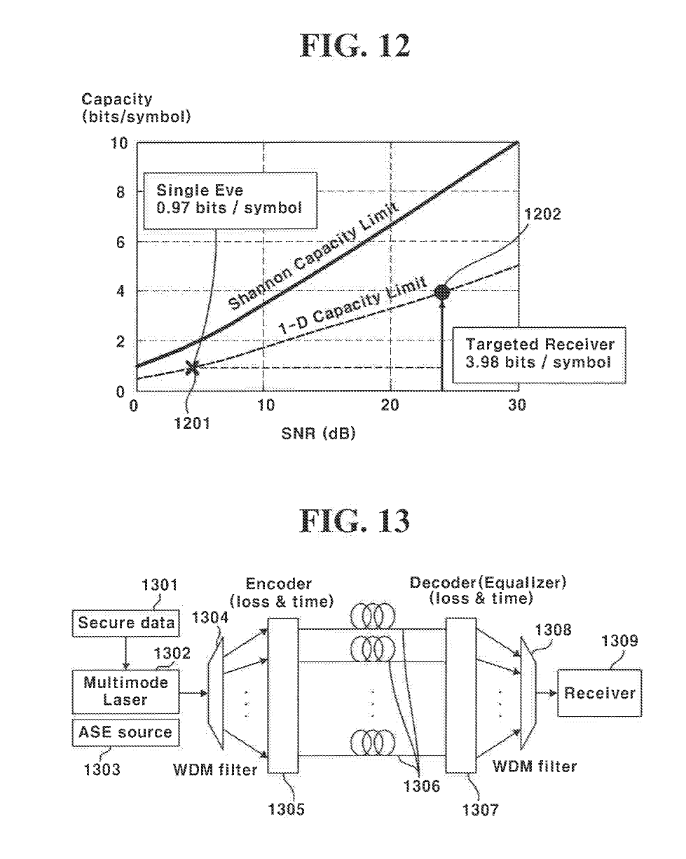

FIG. 12 is a schematic view illustrating a result calculating a maximum channel capacity possessed by a targeted receiver and an eavesdropper (Eve) based on a noise according to an exemplary embodiment of the present invention.

Referring to FIG. 12, it can be ascertained that the security capacity is at maximum 3.01 bits/symbol based on a single polarization (a difference between 1202 and 1201). The security capacity may be maximum 6.02 bits/symbol when two polarizations are all used.

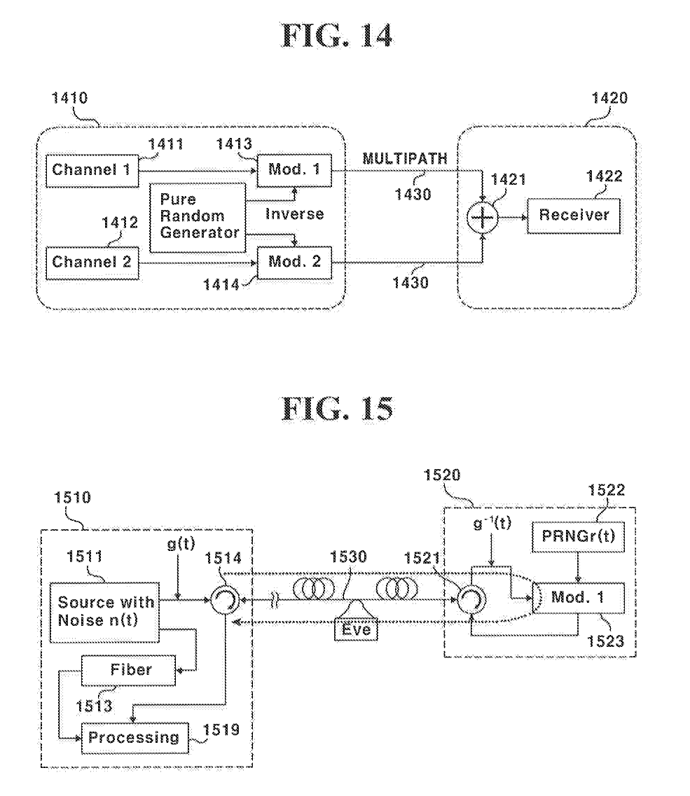

FIG. 13 is a schematic view illustrating an example applied with multipath security system in an optical communication according to an exemplary embodiment of the present invention.

Referring to FIG. 13, an example applied with the multipath security system may include a security data (1301), a multimode laser (1302), an ASE (Amplified Spontaneous Emission), a first WDM filter (1304), a signal modulator (1305, encoder), an optical communication line (1306), a signal demodulator (1307, decoder), a second WDM filter (1308) and a receiver (1309).

The security data (1301) is information desired by a transmitter to be transmitted to a receiver in secret, or information desired to be shared with a receiver. The multimode laser (1302) is a laser having several oscillating modes at a particular wavelength band, and to be more specific, may include a fabry-perot laser diode. The ASE (Amplified Spontaneous Emission) is a light source outputting a light of broad wavelength band, and may restrict noises existing at each mode of the multimode laser (1302.) by infusing the outputted light into the multimode laser (1302).

The first WDM filter (1304) is an optical filter distributing a light of broad wavelength band to several paths by receiving the light and more particularly, may include an AWG (Arrayed Waveguide Grating). The first WDM filter (1304) may perform a function of dividing the multimode light transmitted from the multimode laser (1302) to several paths depending on wavelengths. Here, although noises are small when multi modes are all mutually added, the each light on a path divided by the first WDM filter (1304) may be serious in noise over a light before being divided by the first WDM filter (1304).

The signal modulator (1305, encoder) may perform a function of modulating a signal transmitted from the first WDM filter (1304) to various shapes. The optical communication line (1306) is a communication line passed by a signal desired to be sent by a transmitter to a receiver, and may include a multipath as illustrated in FIG. 13.

The signal demodulator (1307, decoder) is a device demodulating a signal transmitted to a transmitter through the optical communication line (1306), and may perform an operation of compensating the mutually different communication lengths at each path of the optical communication line (1306) in order to remove the source noise. The second WDM filter (1308) is an optical device collecting lights of mutually different wavelength bands and moving the lights to one path, and may offset the noises of individual modes because each mode of serious noises can be collected again in consort with a time. As a result, a total noise of signal transmitted to a receiver (1309) can be reduced. The receiver (1309) may be a device reading information by receiving an optical signal, and may use a coherent detection method in order to increase sensitivity relative to a signal.

The multipath security system explained through FIG. 13 may be applied not only to an optical communication line but also to a case where wired communication and wireless communication are used at the same time. To be more specific, the multipath security system may be applied to a multipath security system of wired communication and wireless communication, a multipath security system of wireless communication and wireless communication, and a multipath security system of wired communication and wired communication. Here, the wired communication may be a communication using an optical communication line and a copper line, and the wireless communication may be a cellular phone network and Wi-Fi. Particularly, the cellular phone network may be used for calculation necessary for generation of encryption key between transmitter/receiver.

Furthermore, in case of MIMO communication method using a noise, only one path may be used for the wired network in the multipath security system, and in case of wireless communication method, a technique of adjusting a signal to be concentrated to a receiver side, that is, a technique of beam forming using an antenna may be usefully utilized.

FIG. 14 is a schematic view illustrating an example applied with multipath security system using a noise according to an exemplary embodiment of the present invention.

The security information, before being transmitted through a signal source, is may be divided to a plurality of transmission signals (1411, 1412) through a signal distributor, where at least two noises generated from a complementary noise device (1415) are infused. Furthermore, each of the noise-infused plurality of transmission signals may be transmitted to a receiver through mutually different plurality of paths (1430). A receiver (1420) may combine the plurality of transmission signals noise-infused through the mutually different plurality of paths (1430) through a signal combiner (1421). Here, the at least two noises generated by a complementary noise device (1415) is 0 in terms of its total sum, whereby the receiver (1420) can accurately obtain security information to be transmitted by a transmitter (1410). Here, a laser used as a light source may be a single mode or a multiple mode. Furthermore, the bandwidth, in case of using one path, may be so narrow as to be almost impossible for communication, which enables a more perfect protection against eavesdropping of an eavesdropper.

Now, the abovementioned discussion is to be explained in more detail using FIG. 14.

Here, a transmission terminal (1410) may include a pure random generator (1415) generating a complementary pure random noise, and at least two noise generated from the pure random generator may be infused into information outputted from each channel (1411, 1412). Here, the channel 1 (1411) and the channel 2 (1412) are channels applied with an arbitrary communication signal and may encompass all communication channels including an optical communication and wireless communication. Furthermore, modulators (1413, 1414) may include a first modulator (1413) and a second modulator (1414) each formed at each channel, and may modulate a signal transmitted from each channel (1411, 1412) using at least two noises transmitted from the pure random generator (1415).

Here, the receiving terminal (1420) may offset the complementary pure random noises by combining signals of two channels by setting up the modulation of the first modulator (1413) and the second modulator (1414) in a mutually adverse manner. Thereafter, the noise-infused information may be transmitted to the receiving terminal (1420) through mutually different plurality of paths, where the receiving terminal (1420) may combine the noise-infused information to offset the complementary noises, and accurately and rightly obtain the information desired to be transmitted from the transmission terminal (1410).

FIG. 15 is a schematic view illustrating an example applied with a single path security system using a noise according to an exemplary embodiment of the present invention.

Referring to FIG. 15, when a one side path of noise is possessed by a first communication user (1510) and the other one path is used to perform a bidirectional.

communication, an eavesdropper (Eve) cannot effectively eavesdrop the information because there is no method to offset the noises.

Now, the abovementioned discussion will be explained in more detail with reference to FIG. 15.

When signals mixed with complementary noises are generated from a signal source (1511), one of the signals may be transmitted to a second communication line (1530) through a first circulator (1514), and the other signal may be transmitted to a first communication line (1513) embedded in a transmitter (1510). That is, any one signal transmitted to the second communication line (1530) is shared by a first communication user (1510) and a second communication user (1520). The second communication user (1520) having received any one signal in the signals mixed with complementary noise from the first communication user (1510) may modulate the signal using a PRNG (Pure Random Number Generator, 1522) and transmit the relevant modulated signal to the first communication user (1510) again, where the first communication user (1510) may offset the noise by combining another signal transmitted from the first communication user (1513) and the modulated signal returned from the second communication user (1520) and obtain a signal transmitted by the second communication user (1520).

Here, the signal source (1511) may output a signal mixed with the complementary noise in order to restrict the eavesdropping of an eavesdropper, and each signal mixed with the complementary noise may be transmitted to the first communication line (1513) and the second communication line (1530).

g(t) and g-1(t) are encryption keys secretly shared by the first communication user (1510) and the second communication user (1520), and may be used in order to maintain a security when a signal is modulated and demodulated. The first communication line (1513) is a separate path distinguished from the second communication line (1530) connected to the second communication user (1520), and is internally managed by the first communication user (1510). A length of the first communication line (1513) must be twice the length of the second communication line (1530).

The first circulator (1514) is an optical device that receives a signal encrypted (encoded) in g(t) and transmits the encrypted signal to the second communication line (1530), and transmits the signal transmitted through the second communication line (1530) to a controller (1519).

The second communication line (1530) is a communication channel that the first communication user (1510) and the second communication user (1520) share a signal, where, because the signal reciprocates the second communication line (1530), the length of the first communication line (1513) must be twice the length of the second communication line (1530) in order to remove the noise from the controller (1519).

The second circulator (1521) is an optical device that transmits a signal transmitted through the second communication line (1530) to the modulator (1523) and transmits again the signal modulated by the modulator (1523) to the second communication line (1530). The PRNG (1522) is a device that generates a random number that cannot be predicted in its pattern because of having no pure interrelationship, and performs a function of disabling an eavesdropper from predicting a pattern when eavesdropping an encryption key. The modulator (1523) is a device that modulates a signal source transmitted from the second circulator (1521) to reflect a random number generated by the PRNG (1522). The controller (1519) is a device that adds a signal transmitted from the first communication line (1513) and a signal transmitted through the second communication line (1530) to offset the noise and reads a signal (e.g., encryption key) modulated by the second communication user (1520) through the modulator (1523).

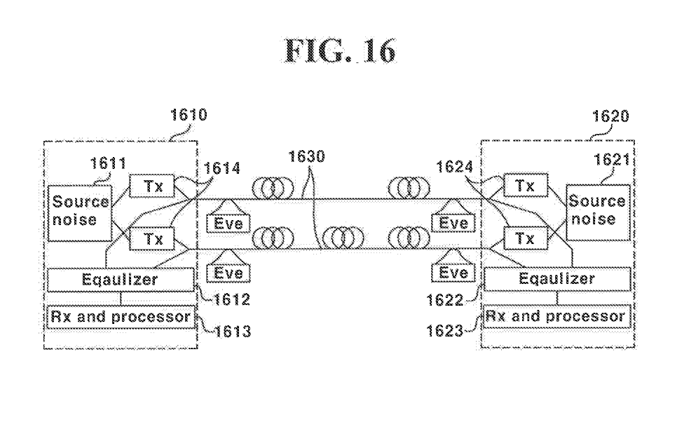

FIG. 16 is a schematic view illustrating an example applied with a bi-directional multipath security system according to an exemplary embodiment of the present invention.

Referring to FIG. 16, an example of bi-directional multipath security system may include a source noise (1611, 1621), an equalizer (1612, 1622), a signal receiver and processor (1613, 1623, Rx and Processor), a signal transmitter (1614, 1624, Tx) and a multichannel (1630).

The source noise (1611, 1621) may be a signal source that generates a signal mixed with noises and transmits the noise-mixed signal to the transmitter (1614, 1624). The equalizer (1612, 1622) may perform a function of restricting noises before the signal receiver and processor (1613, 1623) receives a signal received from an opposite party and physically compensating distortion phenomenon of signal generated while passing through the multichannel (1630). The signal receiver and processor (1613, 1623, Rx and Processor) is a device that receives a signal transmitted from the equalizer (1612, 1623) and processes the received signal. Each of the transmitters (1614, 162.4) may be a device that modulates a signal mixed with noises transmitted from the source noise (1611, 1621) and transmits the modulated signal to the multichannel (1630). The multichannel (1630) may be a communication line through which a first communication user (1610) and the second communication user (1620) exchange a signal and may be various wired and wireless communication channels. Here, each channel included in the multichannel (1630) makes a signal difficult to be recognized/distinguished and enables a bi-directional communication. In case of a single eavesdropper, the attack by the single eavesdropper cannot properly distinguish a signal due to the signal being mixed with noises, as explained above, and the eavesdropper must eavesdrop a signal from all paths of multichannel, in order to remove the noise.

Meantime, although FIG. 16 shows a case of the multichannel (1630) being of two paths, the present disclosure is not limited thereto, and the multichannel (1630) may include at least one path. Furthermore, although FIG. 16 illustrates that two transmitters (1614, 1624) are included by individual communication user, this is to show the convenience of explanation, and the present disclosure may include at least two transmitters (1614, 1624).

Furthermore, because each channel included in the multichannel performs bi-directional communication, and the eavesdropping at a position nearer to a transmitter is easy to eavesdrop because of increased channel capacity, at least two eavesdroppers for each channel must attempt to eavesdrop at a position maximally nearer to a communicator. That is, in case of FIG. 16, although an attempted eavesdropping by at least four (4) eavesdroppers increases the possibility of success, the plurality of eavesdroppers may experience difficulty in concealing their existence from the security system as many as the number of eavesdroppers is increased.

As discussed above, the apparatus and method for high speed communication with perfect secrecy according to the present disclosure can be applied to mutually different communication networks, and make it difficult for an eavesdropper (Eve) to eavesdrop by implementing each communication network in different paths. For example, when a first path included in a communication network is implemented in a cellular network, a second path is implemented in an optical communication network and a third path is implemented in a wifi network, and information is transmitted by mixing these methods, the eavesdropping by an eavesdropper (Eve) becomes even more difficult, and therefore, the security of relevant communication network can be further perfected.

In sum, the apparatus and method for high speed communication with perfect secrecy according to the present disclosure can fundamentally block the eavesdropping possibility per se using a physical characteristic embedded in a channel, and can increase an encryption key generation speed up to a transmission speed of conventional information, and can be applied to or used to various communication channels including various technologies of conventional optical communication.

In the above, exemplary embodiments of the present disclosure have been described. However, these embodiments are merely examples and do not limit the present invention, so that persons who skilled in the art of the present disclosure may easily transform and modify within the limit of the technical spirit of the present disclosure. For example, each of the components shown in detail in the embodiments of the present invention may be implemented in transformation. In addition, the differences relating these transformations and modifications shall be regarded to be included in the scope of the present disclosure as defined in the attached claims of the present disclosure and the equivalents thereof.

1. An apparatus for high speed communication with perfect secrecy disposed with an OTDR (Optical Time Domain Reflectometer) increased in sensitivity, wherein the sensitivity-increased OTDR includes:
a first light source applying a first optical pulse to an optical communication path;
a coupler outputting the first optical pulse by dividing the first optical pulse at least more than two paths;
a photodetector determining a point applied with the first optical pulse on the optical communication path;
a second light source applying a second optical pulse to an optical communication path weaker in intensity than that of the first optical pulse in response to a point applied with the first optical pulse to the optical communication path;
an optical receiver receiving an optical signal returning by being reflected from the optical communication path; and.
a controller analyzing or predicting a signal leakage of the optical communication path based on a result detected from the optical receiver.

2. The apparatus of claim 1, further comprising:
a first circulator transmitting a first optical pulse outputted from the coupler to the optical communication path, and transmitting the optical signal returning by the first optical pulse being reflected from the optical communication path to the optical receiver; and
a second circulator transmitting a second optical pulse outputted from the second light source to the optical communication path and transmitting an optical signal returning by the second optical pulse from the optical communication path.

3. The apparatus of claim 2, further comprising: a delay line connected to the photodetector to transmit a signal controlling operations of the second light source and the optical receiver based on a point of the first optical pulse being applied to the optical communication path to the second light source and the optical receiver.

4. The apparatus of claim 2, further comprising: a WDM (Wavelength Division Multiplexing) filter disposed between the first and second circulators to transmit optical pulses of mutually different wavelengths received from the first and second circulators to the optical communication path, and to transmit each optical signal of mutually different wavelengths that return by being reflected from the optical communication path by dividing the optical signals of mutually different wavelengths to the first and second circulators.

5. The apparatus of claim 2, wherein the optical signal including the second optical pulse that returns by being reflected from the optical communication path includes an optical signal reflected by the second optical pulse in response to a refractive index corresponding to an instant point to catch up the first optical pulse.

6-8. (canceled)

9. The method of claim 24, wherein a sum of n number of noises is 0, and the second communication user obtains the transmission signal by offsetting the n number of noises.

10. The method of claim 24, wherein the n number of noises is generated by a complementary noise generator and the step of transmitting, by a first communication user, to a second communication user, a transmission signal respectively infused with n number of noises (n is a natural number greater than 1) through in number of communication paths (m is a natural number greater than 1) includes a step of performing a signal modulation and distributing to the in number of communication paths, based on any one noise and the transmission signal among the n number of noises.

11. The method of claim 24, further comprising generating the n number of noises, and the step of generating the n number of noises includes:
distributing an optical source to a p number of channels (p is a natural number greater than n) by passing an output of BLS (Broaden Light Source) having a broad wavelength band to a first AWG (Arrayed Waveguide Grating);
infusing to an RSOA (Reflective Semiconductor Optical Amplifier) by coupling the n number of optical source in the optical sources distributed to the p number of channels using a BS (Beam Splitter); and
classifying an output of the RSOA as the n number of noises by passing a second AWG.

12. A method for high speed communication with perfect secrecy, the method comprising:
outputting an optical source corresponding to at least two modes based on a security data and multi-node laser;
distributing the optical source to at least two paths based on a first WDM filter;
modulating a signal transmitted from the first WDM filter based on a signal modulator;
demodulating a signal transmitted through an optical communication path based on a signal demodulator;
offsetting noises included in individual modes of demodulated signals based on a second WDM filter; and
obtaining the security data.

13. The method of claim 12, wherein the step of outputting an optical source corresponding to at least two modes based on a security data and multi-mode laser includes restricting noises existent in the at least two modes by infusing an output of an ASH (Amplified Spontaneous Emission) to the multi-mode laser.

14. A method for high speed communication with perfect secrecy, the method comprising:
dividing a security data to at least two transmission signals;
at least two signals being modulated to at least two noise sources;
each of the at least two transmission signals infused with the at least two noises being transmitted to a receiver through mutually same or mutually different channels; and
obtaining the security data based on the at least two transmission signals included with the at least two noises received by the receiver.

15. The method of claim 14, wherein a sum of the at least two noises is 0, and the receiver offsets the at least two noises to obtain the security data.

16. A method for high speed communication with perfect secrecy, the method comprising:
transmitting, by a first communication user, to a second communication user, a signal include with a part of noises in a plurality of complementary noises through a single path and storing remaining noises in the plurality of complementary noises through other paths;
generating a transmission signal by modulating the signal received by the second communication receiver and transmitting the transmission signal to the first communication user through the single path; and
obtaining the transmission signal based on a modulated signal returned by the first communication user to the second communication user and the stored remaining noises.

17. The method of claim 16, wherein the step of obtaining the transmission signal based on a modulated signal returned by the first communication user to the second communication user and the stored remaining noises includes obtaining the transmission signal by offsetting the plurality of complementary noises by aggregating the modulated signal returned by the first communication user from the second communication user with the stored remaining noises.

18. The method of claim 21, wherein the first communication user and the second communication user share in secret the encryption key used for modulation and demodulation of signals.

19. The method of claim 16, wherein a length of the different path is twice the length of the single path.

20. The method of claim 16 further comprising:
modulating, by each of the first communication user and the second communication user, a signal relative to noises based on at least two signal transmitters and source noise;
transmitting, by each of the first communication user and the second communication user, the modulated signal to other users through at least one path; and
restricting, by each of the first communication user and the second communication user, noises included in the received signal and compensating a distortion phenomenon of the signal, wherein the at least one path includes at least one communication network in an optical communication path realized for bi-directional communication, a wireless communication channel and wired communication channel.

21. The method of claim 16 further comprising:
transmitting a first key (K1) to the second communication user by generating, by the first communication user, the first key (K1);
transmitting to the first communication user by generating, by the second communication user, a second key (K2); and
obtaining, by the first communication user or the second communication user, the encryption key based on the first key and the second key.

22. The method of claim 21 wherein the first communication user and the second communication user are mutually connected through at least one communication path, and a channel capacity between the first communication user and the second communication user is greater than that between the first communication user or the second communication user and an eavesdropper.

23. The method of claim 16 wherein transmitting a signal having a part of noises in a plurality of complementary noises through a single path and storing remaining noises in the plurality of complementary noises through other paths comprises transmitting, by the first communication user, to the second communication user, the signal respectively infused with n number of noises (n is a natural number greater than 1) through m number of communication paths (m is a natural number greater than 1); and
wherein obtaining the transmission signal comprises obtaining the transmission signal, based on a transmission signal respectively contained with the n number of noises received by the second communication user.
